(19) United States
(12) Patent Application Publication
(10) Pub. No.: US 2023/0086319 A1
(43) Pub. Date: Mar. 23, 2023

(54) ASSESSING DATA RECORDS

(71) Applicant: JPMorgan Chase Bank, N.A., New York, NY (US)

(72) Inventor: Logan MALLORY, Chicago, IL (US)

(21) Appl. No.: 17/477,563

(22) Filed: Sep. 17, 2021

(51) Int. Cl. G06Q 40/02

(52) U.S. Cl. CPC G06Q 40/025

(57) ABSTRACT

In one example, a method for assessing data records is disclosed. The method maps a plurality of keys to a respective plurality of the pools of records. The mapping operation may include mapping a first key to a first pool of records of a first array and mapping a second key to a second pool of records of a second array. The method applies logic rules to values of the pools of records that are in the same index or position of the first and the second array to generate a risk assessment score for a record corresponding to that index or position.

### BACKGROUND

Industry best practices along with financial regulations may mandate that financial institutions conduct financial risk assessments of all new and existing customers. An example of such a financial regulation is the GFCC (Global Financial Crimes Compliance) regulation. Another example is the AML (anti-money-laundering/know-your-customer) regulation. Such financial regulations may include provisions that facilitate oversight of financial institutions and their customers/clients.

### BRIEF DESCRIPTION OF THE DRAWINGS

Examples of the disclosure will be rendered by reference to specific examples which are illustrated in the appended drawings. The drawings illustrate only particular examples of the disclosure and therefore are not to be considered to be limiting of their scope. The principles here are described and explained with additional specificity and detail through the use of the accompanying drawings.

FIG. 1 illustrates a system for assessing data records to determine customer financial risks according to an example of the present disclosure.

FIG. 2 illustrates an example of a risk model and a customer pool syntax for the logic engine of FIG. 1.

FIG. 3A is an object-oriented syntax to add an amount of points to the total of a risk assessment score of a customer.

FIG. 3B illustrates a customer-pool syntax in accordance with examples of the present disclosure.

FIG. 4 is a data assessment method 400 according to examples of the present disclosure.

### DETAILED DESCRIPTION

A risk assessment model and/or logic rules engine is used to conduct financial risk assessments of new and existing customers. Specifically, a risk assessment model and/or logic rules engine can be used to determine a customer's overall score, a category-specific risk score, and whether the customer is a low, medium or high financial risk customer. Many such risk assessment models often need to be updated for any number of reasons. The updates may be to account for changing geopolitical environments, or changes in risk assessment rules, or other unforeseen variables.

However, implementing a risk assessment model update can be an arduous task because when any model update is implemented, a corresponding impact analysis of that update must also be performed. An impact analysis determines whether or not the updated logic rules will adversely impact any existing customer data. As an example, the updated risk assessment model should not incorrectly classify a low-financial-risk customer as being high risk. This entire process, including the update and the corresponding impact analysis can take many weeks to complete.

And even worse, if the impact analysis reveals an adverse impact, the entire update is discarded. The process is then restarted and repeated with the appropriate logic changes which then takes much longer. Furthermore, this process can take additional time if the impact analysis is for a large data set such as that for a large financial institution that has millions of clients. Oftentimes, in such cases, the impact analysis is conducted on a small sample of existing customers to save time.

Accordingly, examples of the present disclosure address the foregoing by providing a system and method for assessing data records to generate a risk assessment score. For some examples, the method begins by mapping multiple keys to respective pools of records, each pool of records having corresponding values. The pools of records may be obtained by restructuring customer records into a combined data pool of records. The mapping operation may include mapping a first key to a first pool of records of a first array and mapping a second key to a second pool of records of a second array. The method then applies logic rules to values of the pools of records that are in the same index or position of the arrays to generate a risk assessment score.

In this manner, by restructuring the data structure of customer records into a combined pool of records, the present disclosure achieves aggressive data compression resulting in a 100× (one hundred-fold) magnitude increase in data compression. The result is a fast, efficient and less time consuming risk assessment model update process. Both the risk model updates and the impact analyses can be performed quickly in a matter of minutes instead of many weeks to complete. And, generation of the actual risk assessment score is much faster with an execution time of 800 ms instead of many days.

If the impact analysis reveals an adverse impact, restarting and repeating the process with the appropriate logic changes is seamless and effortless. And the impact analysis is not limited to data set samples but can be applied to large datasets as with large financial institutions that have upwards of a hundred million clients.

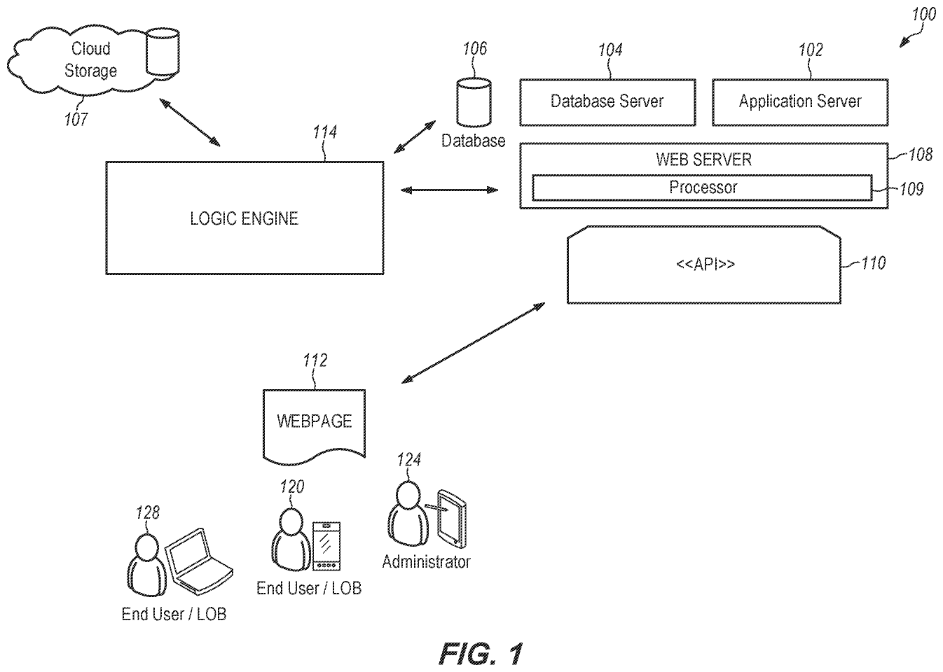

FIG. 1 illustrates a system 100 for assessing data records to determine customer financial risks according to an example of the present disclosure. In FIG. 1, the system 100 includes an application server 102 and a database server 104.

As implied by its name, database server 104 is a computing server that uses a database application, e.g., SQL (Structured Query Language), to manage data on one or more databases 106. The data management (by database server 104) may include storing, retrieving and authenticating end-user access to all of the data stored on database 106. Database 106 may also store customer records (of a financial entity, for example).

Application server 102 may include computing software or code to execute web or desktop applications for use by system 100. Application server 102 may also include runtime libraries and connectors to database 106. As shown, application server 102 may be behind a web server 108 (including a processor 109).

Web server 108 may be a combination of software and/or hardware that accepts HTTP requests initiated via a webpage 112. Any one of end user 120 and end user 128 may initiate communication via webpage 112 by making a request for a specific resource using HTTP. Then the web server 108 can respond with either the content of that resource or with an error message.

In one implementation, end user 128 may request via webpage 112 to add, edit or delete customer records; responsively, web server 108, in conjunction with application server 102 and database server 104, may fulfill the user request. Similarly, an administrator 124 may be tasked to implement risk model changes (via webpage 112 or other internal user interfaces within the enterprise data network).

As used in the present disclosure, a risk model is a list of risk rules that can be applied to a pool of customers to generate risk assessment scores. An example of such a risk rule is “V:politically-exposed=“Yes” OR V:client-country-codes in C:high-risk-countries.”

In FIG. 1, system 100 further includes an API (Application Programming Interface) 110 and a logic engine 114 that are used to apply logic rules to data such as the customer records of an entity including financial institutions or other entity types. Logic engine 114 may be a module, software, or program (usually self-contained) that takes in a set of variables and corresponding values, evaluates a set of predefined conditions, and builds a result set based on true condition.

API 110 may be a set of communication protocols to receive user requests to analyze the impact of risk model changes on customers as will be further described below. Such requests may then be delivered to logic engine 114 for execution. Similarly, for some examples, API 110 may receive customer scoring requests from other applications and then deliver the customer scoring requests to logic engine 114 for execution.

As shown in FIG. 1, the logic engine 114 may be communicably coupled to a cloud storage 107 and database 106. As implied by its name, cloud storage 107 may be a remotely stored cloud such as S3™ to store available risk models. In contrast, because database 106 is local and within a secure enterprise data network (not shown), database 106 may store customer records and other highly sensitive data.

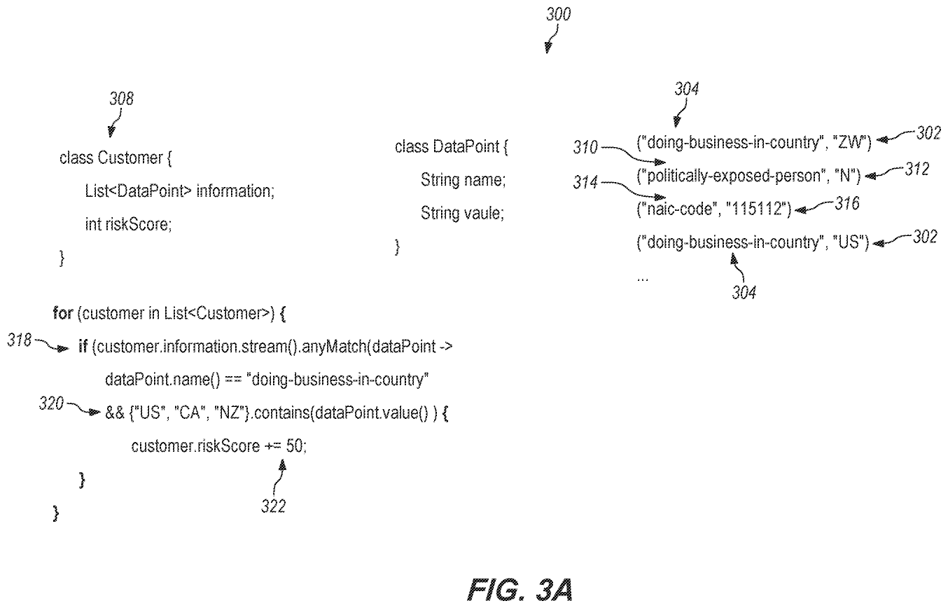

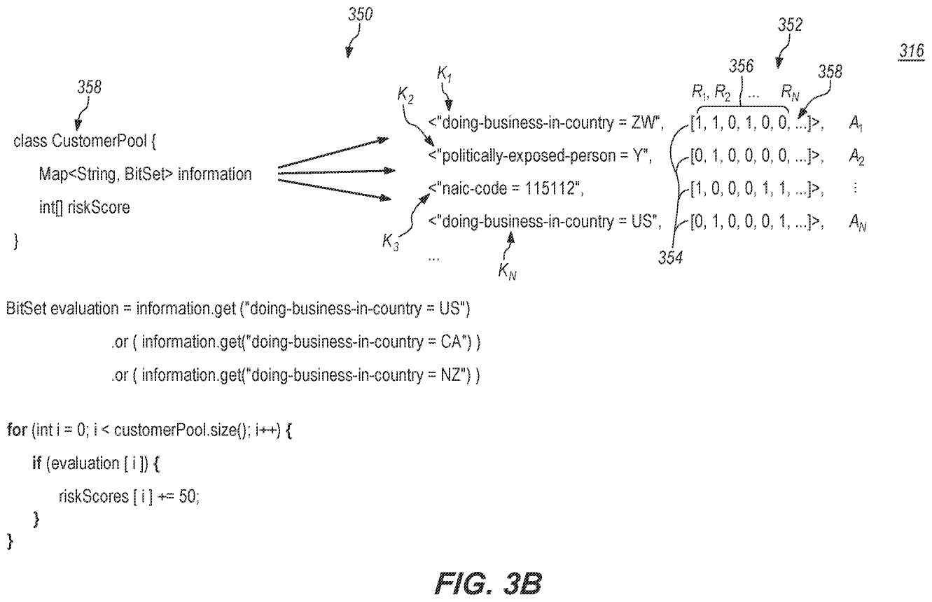

Specifically, for some examples, the present disclosure combines customer records into a customer data pool to achieve compression of large amounts of data and to facilitate the generation of risk assessment scores and the corresponding impact analysis. Here, a customer data pool, as used herein, is composed of values from across a plurality of customer records (e.g., R₁, R₂ . . . N^{th} of FIG. 3B).

For example, a first customer record may have the following values or datapoints: name=John Doe; doing-business-in-country=ZW, CA; politically-exposed-person=No; naic-code=115112. A second customer record R₂ may have: name=Jane Doe; doing-business-in-country=ZW, US; politically-exposed-person=Yes; naic-code=441221. An N^{th} customer record R_{N} may include: name=Peter Doe; doing-business-in-country=CA; politically-exposed-person=No; industry-code=441221.

Based on the above, a first customer data pool for above records may include the names: John Doe, Jane Doe, and Peter Doe. In other words, a customer data pool includes values from a row of a plurality of customer records. Another example of a customer data pool based on the above records may include the datapoints: doing-business-in-country=NZ; doing-business-in-country=CA; naic-code=441221; and doing-business-in-country=US. Further yet, another example of a customer data pool includes the values: naic-code=115112, naic-code=441221.

As further described below with reference to FIG. 3B, the customer data pools may be stored as a plurality of arrays where the same position of the plurality of arrays is associated with each individual record and a plurality of keys may be mapped to the data pool of each array.

In one implementation, the present disclosure achieves aggressive data compression resulting in a 100× (one hundred-fold) magnitude increase in data compression by restructuring customer records from a data structure where each customer record has its own individual dataset to a data structure where customer records are combined into a customer data pool.

Briefly, in operation, end user 128 may be an internal end user from a line of business (LOB) of a financial entity. End user 128 may desire a financial risk assessment score for a new customer. End user 128 begins by using webpage 112 to send a financial risk assessment score request to API 110 and web server 108.

In turn web server 108 and/or application server 102 may include one or more processors to cause the logic engine 114 to apply logic rules to the customer data pool (having restructured and compressed customer data) to generate a risk assessment score. Specifically, logic engine 114 may request the latest risk model from cloud storage 107. Logic engine 114 then uses the risk model to score the customer or collection of customers identified in the request.

End user 120 may also employ system 100 to view the impact of changes to risk models. End user 120 may send a request to view the impact of changes that have been made to a particular risk model by end user 120. System 100 receives the request and causes logic engine 114 to request the target customer pool from database 106. Logic engine 114 then applies logic rules based on the modified risk model to the customer data pool (having restructured compressed customer data) and then displays the impact change results to end user 120.

The impact change results might include the level of risk (high, medium or low) or a risk assessment score. Such a level of risk or risk assessment score may reveal that the change to the modified risk model has inadvertently misclassified a low-risk customer into a higher risk category (for example). In such cases, end user 120 may discard the modified risk model and restart the risk model revision process. The impact change results may also include evaluations of the risk assessment rules used to score the customer records that may indicate the relative importance of each rule. Additionally, impact change results may be further summarized by their associated risk category.

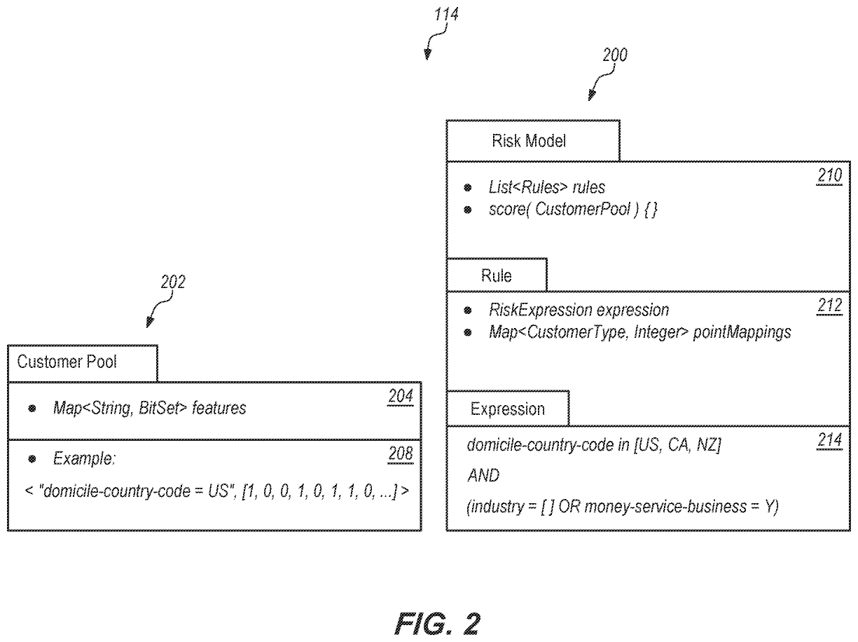

FIG. 2 illustrates an example of a risk model 200 and a customer pool 202 syntax for logic engine 114 of FIG. 1. In one example, logic engine 114 may be caused by a processor (e.g., 109 of FIG. 1) to apply logic rules to BitSet values of customer pool 202.

In FIG. 2, customer pool 202 may include a map 204 object that maps a string (key) to a BitSet of 1s and 0s: map<string, bitset>features. As an example, at 208, the key “domicile-country-code=US” is mapped to the BitSet [1, 0, 0, 1, 0, 1, 1, 0,].

The risk model 200 may include a list 210 interface that implements multiple rules such as rule 212. The rule 212 may itself be based on a logical combination of expressions 214 such as “domicile-country-code in [US, CA] AND (industry=[ ] OR money-service-business=Y) as in FIG. 2.

FIG. 3A is an object-oriented syntax 300 to add an amount of points to the total of a risk assessment score of a customer 308. Specifically, in FIG. 3A, line of code 318 illustrates that if customer 308 is doing business in the US, CA, or NZ as shown at 320, a 50-point score (shown at 322) is added to the customer's risk assessment score. In this case, the key (question or datapoint) doing-business-in-country 304 has a country code value ZW for Zimbabwe, and US for United States, as depicted as 302. Because customer 308 is doing business in the US, the 50-point score is assigned to customer 308. As such, the risk assessment score of customer 308 is higher indicating that customer 308 may be a higher-risk customer.

Two additional keys, namely politically-exposed-person 310 and naic-code 314, also facilitate risk assessment of a customer. Here, politically-exposed-person 310 has a value N for “no” as shown at 312 and naic-code 314 has a value of 115112 as shown at 316. Note also that if customer 308 were operating in the motorcycle dealership industry (North American Industry Code (NAIC) 441221), object-oriented syntax 300 would include the following key (or datapoints or questions):

class DataPoint {(“naic-code”, “441221”).

To successfully execute the above lines of code, each and every customer record has its own customer 308 object, and its own data set. In other words, for each customer, all of the data including responses to the above questions are stored in a customer 308 object for the customer. As such, if a financial institution has 100 million customers, then 100 million customer objects are stored in memory so that memory consumption by the data structure is a substantial and sizeable 4 TB of memory. The data structure for such a syntax can be very unwieldy and inefficient.

Moreover, scoring 100 million customer objects in this manner takes about 21 days even though memory consumption is low because customers are scored one by one. This object-oriented syntax 300 can also be very inefficient, analyzing risk model impacts by scoring customers one by one and then aggregating the data.

Unlike the system of FIG. 3A, the present disclosure addresses the foregoing by providing an efficient and fast system that enables utilization and compression of a large amount of data. Accordingly, FIG. 3B illustrates a customer-pool syntax 350 in accordance with examples of the present disclosure. Here, as in FIG. 3A, customer-pool syntax 350 also assigns an amount of points to a total risk assessment score.

However, in FIG. 3B, all customers are pooled into a CustomerPool 358. If the pooled customers are doing business in the US, CA, or NZ, a 50 point score is assigned to the customers. Here, unlike the object-oriented syntax 300 of FIG. 3A where each customer has its own data set, the customer-pool syntax 350 of the present disclosure combines and compresses all customer data into a customer data pool.

Specifically, in FIG. 3B, a plurality of customer records R₁, R₂ . . . R_{N} are shown. Here, each one of the values 356 is from a different customer record R₁, R₂ . . . R_{N} combined into a customer data pool 358 or array A₁. For example, the first value 356 is a 1 from customer record R₁. The second value 356 is a 1 from customer record R₂. Thus, the values 356 (1, 1, 0, 1, 0, 0 . . . ) form an array A₁ as previously noted. Note also that the values 356 for the customer data pool 358 are Boolean as will be further described below.

As noted above, in FIG. 3B, each customer record R₁, R₂ . . . R_{N} does not have its own dataset but rather has values 354 that are spread out across a plurality of data pools or arrays A₁, A₂, . . . A_{N}. That is, each individual customer record R₁, R₂ . . . R_{N} is itself composed of values from across the plurality of arrays A₁, A₂ . . . A_{N}. As an example, customer record R₁ has values 1, 0, 1, 0. As another example, customer record R₂ has value 1, 1, 0, 1. Although referred to as records, each customer record R₁, R₂ . . . R_{N} is merely a collection of values in the same position or index of the plurality of arrays A₁, A₂ . . . A_{N}.

The arrays A₁, A₂ . . . A_{N} are all in the same order and also have the same length. Thus, it can be assumed that the first index of each of the arrays A₁, A₂ . . . A_{N} is all the same customer. The second index is all the same customer, and so forth. As noted, the arrays are the same length. If there are 100 million customers in the first array A₁, the next array A₂ also has 100 million customers, and the A_{N}^{th} array has 100 million customers.

An aspect of the present disclosure is that each key (or question) K₁, K₂ . . . K_{N} is respectively mapped to the data pool of each array A₁, A₂ . . . A_{N} (as will be further discussed with reference to FIG. 3). The keys K₁, K₂ . . . K_{N} are themselves restructured to facilitate data compression. Specifically, a key or question that typically has a character sequence for an answer is restructured to incorporate the character sequence into the question. As a result, answers to key questions can be either True or False (Yes or No), which can be represented as a BitSet of 1s and 0s.

For example, a typical question may be: which country are you doing business in? The corresponding answer may be a two-letter country code such as US, CA, NZ, etc. This format requires data storage of questions/responses for each customer. Data compression is facilitated by restructuring such a question to include the country code as follows: “doing-business-in-countries=US.” The answer can then be a 1 if a customer is doing business in the US or a 0 if they are not. Thus, the response for each one of 100 million customers (for example) can be represented by either a 1 or a 0. The result is an array of integers of 1s and 0s as shown in FIG. 3B.

Referring now to FIG. 3B, the arrays A₁, A₂ . . . A_{N} can respectively, form a matrix defined by:
K₁[R₁₁, R₁₂ . . . R_{1N}], K₂[R₂₁, R₂₂ . . . R_{2N}], K_{N}[R_{N1}, R_{N2} . . . R_{NN}], where
   K₁=“doing-business-in-countries=ZW,” R₁₁=1, R₁₂=1 and R_{1N}=0;
   K₂=“politically-exposed-person=Y, R₂₁=0, R₂₂=1 and R_{2N}=0;
   K₃=“naic-code=115112”, R₃₁=1, R₃₂=0 and R_{3N}=1 and
   K_{N}=“doing-business-in-country=US, R_{N1}=0, R_{N2}=1 and R_{NN}=1.

As can be seen, the plurality of keys K₁, K₂, K₃ . . . K_{N} are questions, and the data pool values are corresponding Boolean responses to the questions. Thus, for key (question) K₁ “doing-business-in-countries=ZW,” the response “1” indicates that the customer does business in ZW while a “0” indicates that the customer does not do business in ZW. As another example, for key (question) K₃ “naic-code=115112,” a “1” indicates that customer operates in the agriculture industry, and a “0” indicates that customer does not operate in that industry. In this manner, responses are compressed into BitSet of 1s and 0s such that for 100 million customers for example, a data compression goes from 4 TB for the syntax of FIG. 3A to only 40 GB for examples according to the present disclosure.

Moreover, the restructured data format also plays a role in latency. Because the present data has been compressed into an array of 1s and 0s, questions can be answered quickly sometimes in as little as 5 milliseconds by applying a logical OR to each of the questions. For example, if the question that is answered is “Is the customer doing business in the US or CA or CN or NZ?” that answer can be recorded efficiently by taking doing a logical OR of the compressed array of 1's and 0's so that the result is either a 0 or a 1. The result is a fast, efficient risk assessment scoring and updating particularly for big data.

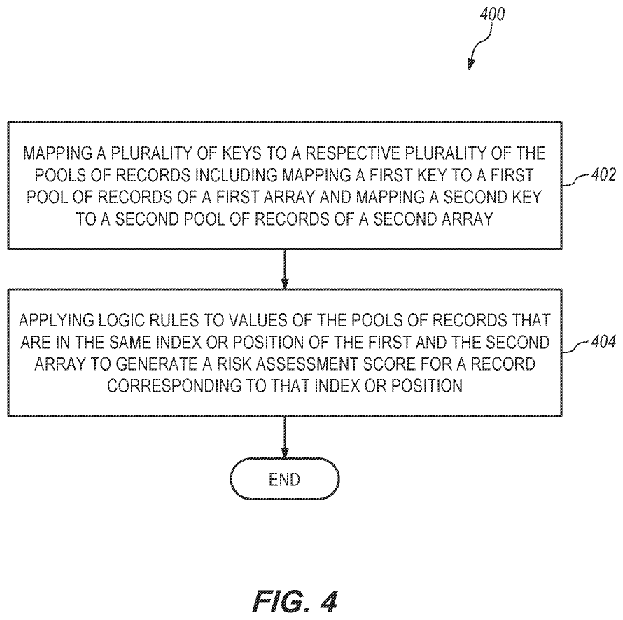

FIG. 4 is a data assessment method 400 for according to examples of the present disclosure. At block 402, in one example, the data assessment method 400 begins by using a map object to map a plurality of keys K₁, K₂, K₃ . . . K_{N} to a respective plurality of the pools of records [R₁₁, R₁₂ . . . R_{1N}], [R₂₁, R₂₂ . . . R_{2N}] [R_{N1}, R_{N2} . . . R_{NN}]. As used herein, a key is a question for which a Boolean value is stored.

The operation of mapping a plurality of keys K₁, K₂, K₃ . . . K_{N} to a respective plurality of the pools of records [R₁₁, R₁₂ . . . R_{1N}], [R₂₁, R₂₂ . . . R_{2N}], [R_{N1}, R_{N2} R_{NN}] may include mapping a first key K₁ to a first pool of records [R₁₁, R₁₂ . . . R_{1N}] of a first array A₁ and mapping a second key K₁ to a second pool of records [R₂₁, R₂₂ . . . R_{2N}] of a second array A₂.

At block 404, the data assessment method 400 applies logic rules to values of the pools of records that are in the same index or position of the first and the second array to generate a risk assessment score for a record corresponding to that index or position.

The present disclosure may employ a software stack to enlist the underlying tools, frameworks, and libraries used to build and run example applications of the present disclosure. Such a software stack may include PHP, React, Cassandra, Hadoop, Swift, etc. The software stack may include both frontend and backend technologies including programming languages, web frameworks servers, and operating systems. The frontend may include JavaScript, HTML, CSS, and UI frameworks and libraries. In one example, a MEAN (MongoDB, Express.js, AngularJS, and Node.js) stack may be employed. In another example, a LAMP (Linux, Apache, MySQL, and PHP) stack may be utilized.

Any suitable programming language can be used to implement the routines of particular examples including Java, Python, JavaScript, C, C++, assembly language, etc. Different programming techniques can be employed such as procedural or object oriented. The routines may execute on specialized processors.

The specialized processor may include memory to store a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a software program.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

While the above is a complete description of specific examples of the disclosure, additional examples are also possible. Thus, the above description should not be taken as limiting the scope of the disclosure which is defined by the appended claims along with their full scope of equivalents.

I claim:

1. A method for assessing data records, the method comprising:
mapping a plurality of keys to a respective plurality of the pools of records including mapping a first key to a first pool of records of a first array and mapping a second key to a second pool of records of a second array; and
applying logic rules to values of the pools of records that are in the same index or position of the first and the second array to generate a risk assessment score for a record corresponding to that index or position.

2. The method of claim 1 wherein the pools of records are to compress customer record data.

3. The method of claim 2 wherein the pools of records are sets of bits of Boolean values, wherein each customer record data in a pool of records includes 1 bit for each respective customer in the record pool.

4. The method of claim 1 wherein values of the pools of records in the same index or position are for the same entity or customer record.

5. The method of claim 2 wherein the customer record data is compressed by pooling values across a plurality of customer records to form the pools of records.

6. The method of claim 1 wherein the risk assessment score for each record is based on the logical OR of values of the pools of records in the same index or position each array.

7. A system for assessing data records, the system comprising:
a logic engine;
a processor; and
a data store to store a plurality of arrays, each array being a data pool composed of values from across a plurality of records, and each record being composed of the values in the same position or index across the plurality of arrays wherein each one of a plurality of keys is respectively mapped to each array;
wherein the processor is to cause the logic engine to apply logic rules to the arrays of the pool of records to generate a risk assessment score for each record.

8. The system of claim 7 wherein the records are R₁, R₂, . . . R_{N}, the arrays are A₁, A₂ . . . A_{N} and, the keys are K₁, K₂, . . . K_{N}.

9. The system of claim 8 wherein the arrays A₁, A₂ . . . A_{N}, respectively, form a matrix defined by K₁[R₁₁, R₁₂ . . . R_{1N}], K₂[R₂₁, R₂₂ . . . R_{2N}], . . . K_{N}[R_{N1}, R_{N2} . . . R_{NN}].

10. The system of claim 9 wherein the risk assessment score for record R₁ is based on R₁₁, R₂₁ . . . R_{N1}.

11. The system of claim 8 wherein values for the pool of customer records R₁, R₂ . . . R_{N} are Boolean.

12. The system of claim 8 wherein the risk assessment score for each record is based on the logical OR of values of the pools of records in the same index or position of each array.

13. The system of claim 8 wherein the plurality of keys K₁, K₂ . . . K_{N} are questions.

14. The system of claim 13 wherein the data pool values are responses to questions.

15. The system of claim 8 wherein the risk assessment score for each record R₁, R₂ . . . R_{N} is based on the OR of each the arrays A₁, A₂, . . . A_{N}.
